(19) United States
(12) Patent Application Publication
(10) Pub. No.: US 2012/0140468 A1
(43) Pub. Date: Jun. 7, 2012

(54) LIGHT EMITTING DIODE LAMP WITH ADJUSTABLE LIGHT FIELD

(75) Inventor: KUO-CHENG CHANG, Chu-Nan (TW)

(73) Assignee: FOXSEMICON INTEGRATED TECHNOLOGY, INC., Chu-Nan (TW)

(21) Appl. No.: 13/309,575

(22) Filed: Dec. 2, 2011

(30) Foreign Application Priority Data
Dec. 7, 2010 (TW) 099142511

(51) Int. Cl. F21V 21/30; F21V 7/00

(52) U.S. Cl. 362/235; 362/249.03

(57) ABSTRACT

An LED lamp includes a first illuminating device, a second illuminating device, a lamp pole and a transmission device. The first illuminating device includes a supporter and a plurality of light sources arranged on the supporter. The second illuminating device includes a supporting board and a plurality of light sources arranged on the supporting board. The lamp pole includes one end connected to the supporter of the first illuminating device. The transmission device is for driving the supporting board to rotate relative to the lamp pole.

### BACKGROUND

1. Technical Field

The present disclosure generally relates to light emitting diode (LED) lamps, and particular to an LED lamp with adjustable light field.

2. Description of Related Art

With the continuing development of scientific technology, LED lamps have been widely used for interior and exterior illumination. In the design of an LED lamp, light field is always one of major concerns. Most LED lamps generally generate butterfly-type light fields or diffusion-type light fields. However, these types of light field are unchangeable, and not always suitable for a particular application.

Therefore, it is necessary to provide an LED lamp whose light field is adjustable.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure.

FIG. 1 is a side view of an LED lamp in accordance with an embodiment of the present disclosure.

FIG. 2 is cross sectional view of the LED lamp of FIG. 1.

FIG. 3 is a view similar to FIG. 1, showing a first working status of the LED lamp of FIG. 1.

FIG. 4 is a second working status of the LED lamp of FIG. 1.

FIG. 5 is a third working status of the LED lamp of FIG. 1.

FIG. 6 is a fourth working status of the LED lamp of FIG. 1.

### DETAILED DESCRIPTION

Reference will now be made to the drawings to describe the present LED lamp, in detail.

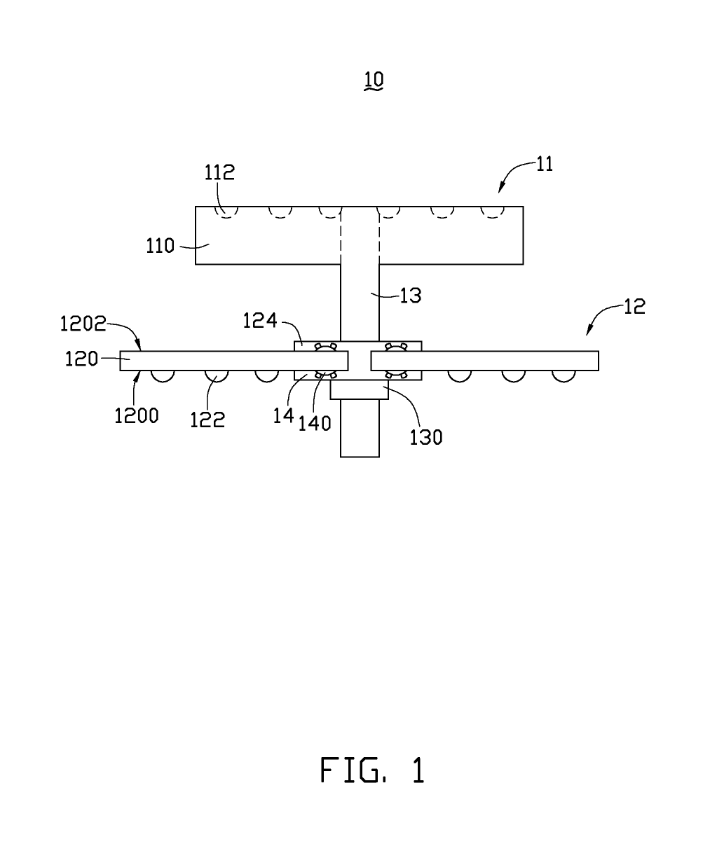

Referring to FIG. 1, an LED lamp 10 according to an exemplary embodiment of the present disclosure includes a first illuminating device 11, a second illuminating device 12, a lamp pole 13 and a transmission device 14.

The first illuminating device 11 includes a supporter 110 and a plurality of light sources 112 arranged on the supporter 110.

The supporter 110 can be made of material with excellent heat conductivity, such as metal, ceramic and so on. The supporter 110 can have any shapes according to requirement. In this embodiment, the supporter 110 has a shape of a brimless hat with a closed top end and an opened bottom end. An inner side wall of the supporter 110 is reflective so it can reflect light incident thereon.

The light sources 112 are arranged on a bottom (i.e., an inner side wall) of the top end of the brimless hat-shaped supporter 110. The light sources 112 are light emitting diodes (LEDs).

The second illuminating device 12 includes two supporting boards 120, a plurality of light sources 122 mounted on a bottom of each of the supporting boards 120, and a bracket 124 mounted to the lamp pole 13. The supporting boards 120 are pivotably connected to opposite ends of the bracket 124.

The supporting board 120 has a plate-like shape. The supporting board 120 can be made of a material with excellent heat conductivity, such as metal, ceramic and so on. The supporting board 120 includes a supporting surface 1200 on the bottom thereof and a rear surface 1202 opposite to the supporting surface 1200 and on a top of the supporting board 120. The rear surface 1202 faces the light sources 112 of the first illuminating device 11.

The light sources 122 are arranged on the supporting surface 1200. The light sources 122 are LEDs.

The bracket 124 sheaths the lamp pole 13, and can be fixed at a selected position along the lamp pole 13. The supporting boards 120 are pivoted to the bracket 124. Therefore, the supporting boards 120 are capable of rotating relative to the lamp pole 13 and the bracket 124, when the bracket 124 is fixed at a desired position of the lamp pole 13.

The lamp pole 13 has its one end connected to the supporter 110, and the other end penetrating through an annular fixing component 130. The fixing component 130 sheathes the lamp pole 13 and can be compressed to clamp the lamp pole 13, thereby fixing the fixing component 130 at a selected position of the lamp pole 13. The bracket 124 can be held at the selected position of the lamp pole 13 by a support of the fixing component 130. In this embodiment, the lamp pole 13 has a column shape and is made of a material as same as that of the supporter 110 and the supporting boards 120.

The transmission device 14 is arranged on the bracket 124. The transmission device 14 is for driving the supporting board 120 to rotate relative to the lamp pole 13, when driven by an exterior motor or the like. In this embodiment, the transmission device 14 includes a gear engaged with the supporting board 120, thereby driving the supporting board 120 to rotate relative to the lamp pole 13 via the gear.

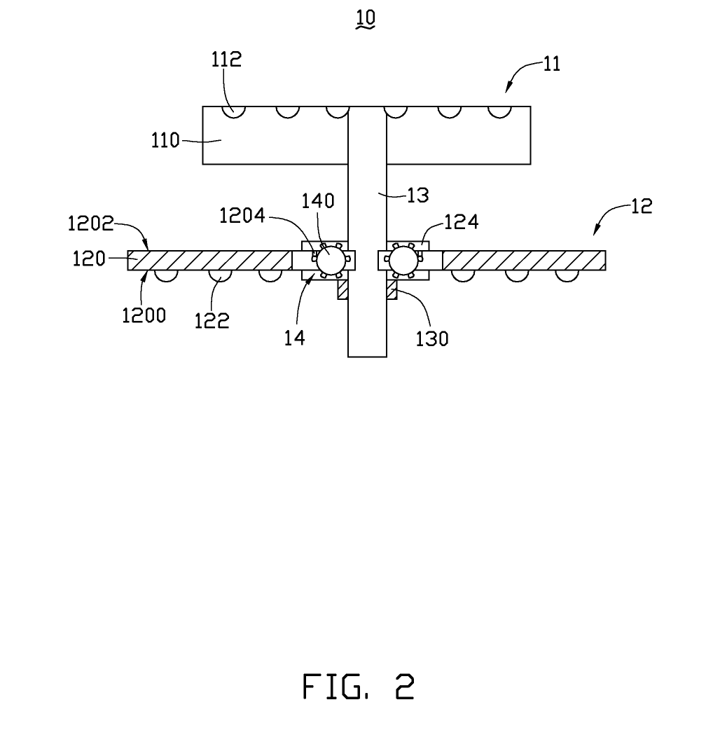

The supporting board 120 has at least one protrusion 1204 (FIG. 2) configured thereon for engaging the gear of the transmission device 14. The protrusion 1204 can be pushed upwardly or downwardly by the gear of the transmission device 14, thereby driving the supporting board 120 to rotate relative to the lamp pole 13 within a limited angle. In other embodiments, the supporting board 120 can also be equipped with a gear engaged with the gear of the transmission device 14 to achieve rotation thereof, instead of the protrusions 1204. When the supporting board 120 is equipped with a gear engaging with the gear of the transmission device, a rotatable angle of the supporting board 120 is increased.

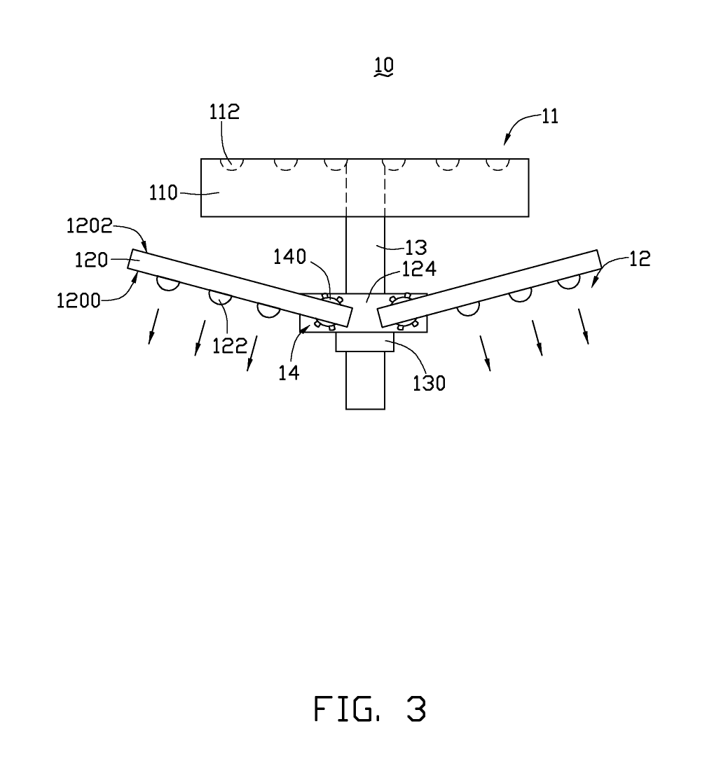

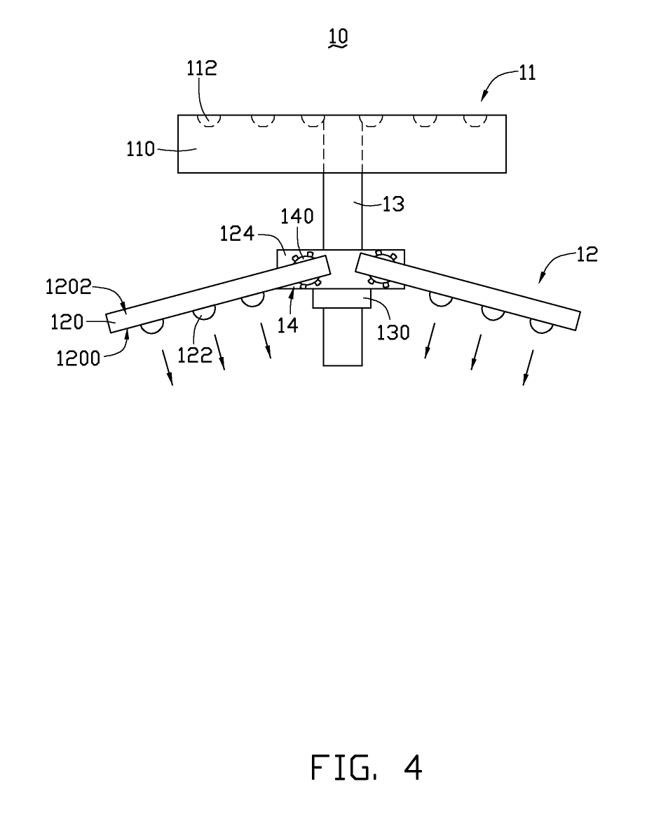

Also referring to FIG. 3 and FIG. 4, due to that the light sources 122 can have different light projecting directions when the supporting board 120 rotates over different directions, a light field of the second illuminating device 12 can be correspondingly adjusted, thereby satisfying particular applications.

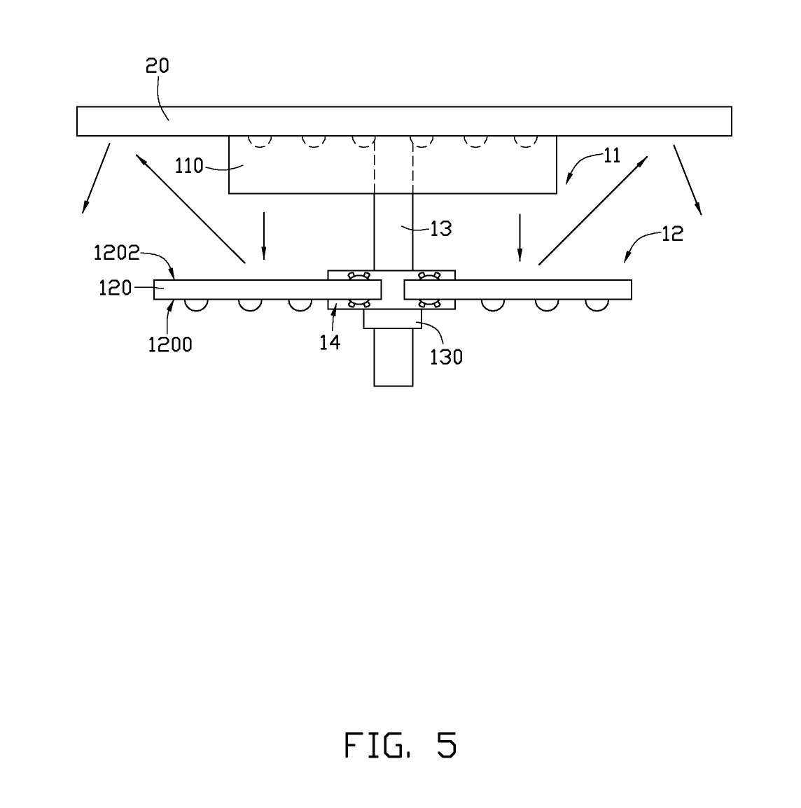

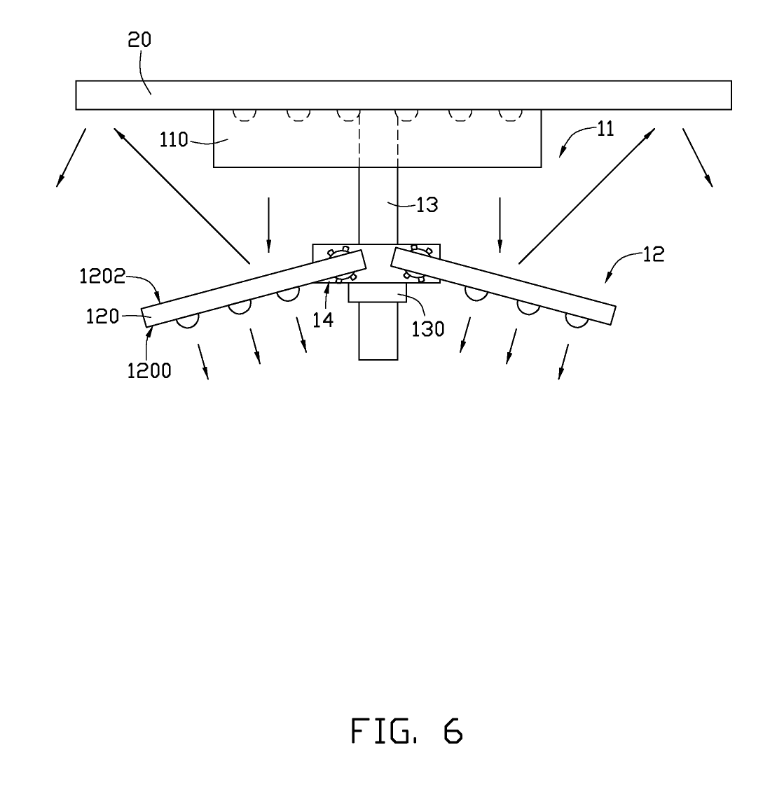

Further referring to FIG. 5, the rear surface 1202 of the supporting board 120 can be configured as a reflective surface for reflecting light emitted from the light sources 112 of the first illuminating device 11, and the lamp 10 is fixed to a reflective board 20 for reflecting light reflected by the rear surface 1202 of the supporting board 120. FIG. 6 shows that such light emitted from the light sources 112 of the first illuminating device 11 can be reflected to different directions by the reflective board 120 when the supporting boards 120 rotate downwardly from the positions as shown in FIG. 5. As such, a light field of the first illuminating device 11 can also be correspondingly adjusted, in addition to the adjustment of the light field of the second illuminating device 12.

It is to be understood that the above-described embodiments are intended to illustrate rather than limit the disclosure. Variations may be made to the embodiments without departing from the spirit of the disclosure as claimed. The above-described embodiments illustrate the scope of the disclosure but do not restrict the scope of the disclosure.

What is claimed is:

1. A light emitting diode (LED) lamp comprising:
a first illuminating device having a supporter and a plurality of LED light sources arranged on the supporter;
a second illuminating device having a supporting board and a plurality of LED light sources arranged on the supporting board, the supporting board comprising a supporting surface and a rear surface opposite to the supporting surface, the light sources of the second illuminating device being arranged on the supporting surface, the rear surface facing the plurality of light sources of the first illuminating device;
a lamp pole with one end connected to the supporter of the first illuminating device; and
a transmission device fixed on the lamp pole and connected to the supporting board of the second illuminating device for driving the supporting board to rotate relative to the lamp pole.

2. The LED lamp according claim 1, wherein the supporter has a configuration of a brimless hat with a closed top and an opened bottom, a bottom of the top of the supporter supporting the plurality of light sources of the first illuminating device.

3. The LED lamp according claim 1, wherein the second illuminating device further comprises a bracket sheathing the lamp pole, the supporting board being rotatably connected to the bracket.

4. The LED lamp according claim 3, wherein the supporting board is pivoted or hinged with the bracket.

5. The LED lamp according claim 3, wherein the lamp pole further comprises a fixing component sheathing the lamp pole, the fixing component clamping the lamp pole and supporting the bracket thereon.

6. The LED lamp according claim 1, wherein the rear surface of the supporting board is a reflective surface for reflecting light from the first illuminating device.

7. The LED lamp according claim 1, wherein the transmission device comprises a gear and the supporting board comprises a protrusion, the gear engaging with the protrusion when the supporting board is driven by the transmission device to rotate relative to the support pole.

8. The LED lamp according claim 1, wherein the transmission device and the supporting board each comprise a gear engaged with each other, the transmission device driving the supporting board to rotate via an engagement of the two gears.
